(19) United States
(12) Patent Application Publication
(10) Pub. No.: US 2010/0082385 A1
(43) Pub. Date: Apr. 1, 2010

(54) SYSTEM AND METHOD FOR DETERMINING TEMPERATURE OF BUSINESS COMPONENTS FOR FINDING BUSINESS TRANSFORMATION OPPORTUNITIES

(75) Inventors: Rong Zeng Cao, Beijing (CN); Wei Ding, Beijing (CN); Shun Jiang, Beijing (CN); Juhnyoung Lee, Yorktown Heights, NY (US); Chun Hua Tian, Beijing (CN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/243,872

(22) Filed: Oct. 1, 2008

(51) Int. Cl. G06Q 10/00; G06F 3/048

(52) U.S. Cl. 705/7; 715/771

(57) ABSTRACT

Temperature of one or more business components are determined by determining temperatures for metrics associated with a business component using benchmark data. The determined temperatures for metrics are aggregated into a representative temperature for a business component using a selected algorithm. A spectrum of colors is provided to represent the range of temperatures and the representative temperature is represented as a color from the spectrum of colors.

### CROSS-REFERENCE TO RELATED APPLICATIONS

This application is related to U.S. patent application Ser. No. ______ entitled, “SYSTEM AND METHOD FOR FINANCIAL TRANSFORMATION,” (attorney docket YOR920080225US1 (22651)), U.S. patent application Ser. No. ______ entitled, “SYSTEM AND METHOD FOR INFERRING AND VISUALIZING CORRELATIONS OF DIFFERENT BUSINESS ASPECTS FOR BUSINESS TRANSFORMATION,” (attorney docket YOR920080271US1 (22690)), U.S. patent application Ser. No. ______ entitled, “SYSTEM AND METHOD FOR FINDING BUSINESS TRANSFORMATION OPPORTUNITIES BY ANALYZING SERIES OF HEAT MAPS BY DIMENSION,” (attorney docket YOR920080273U1 (22692)), U.S. patent application Ser. No. ______ entitled, “SYSTEM AND METHOD FOR FINDING BUSINESS TRANSFORMATION OPPORTUNITIES BY USING A MULTI-DIMENSIONAL SHORTFALL ANALYSIS OF AN ENTERPRISE,” (attorney docket YOR920080274US1 (22693)), filed on even date and assigned to the same assignee in the present application, contents of which are incorporated by reference herein in their entirety. This application is also related to U.S. patent application Ser. No. 12/164,582 entitled, “SYSTEM AND METHOD FOR PLATFORM-INDEPENDENT, SCRIPT-BASED APPLICATION GENERATION FOR SPREADSHEET SOFTWARE,” (attorney docket YOR920080350US1 (22866)), filed on Jun. 30, 2008 and assigned to the same assignee of the present application, contents of which are incorporated by reference herein in its entirety.

### FIELD OF THE INVENTION

The present disclosure relates generally to computer applications, and more particularly to determining temperature of business components for finding business transformation opportunities.

### BACKGROUND OF THE INVENTION

Business transformation is a key management initiative that attempts to align people, process and technology of an enterprise closely with its business strategy and vision. Business transformation is often achieved by taking a holistic look at various dimensions of an enterprise such as business models, management practices, business processes, organizational structure and technology and optimizing them with best-practice or differentiated methods to reach a strategic end state. For example, business transformation in the enterprise finance area would, among others, optimize financial processes such as accounts receivables, eliminate non-value-added tasks, improve efficiency and productivity of people, and reduce errors by using technologies. Business transformation is considered an essential part of the competitive business cycle.

Consulting service companies in the business transformation area brand technology and consulting as their core product and service offerings. These offerings include models, methods and tools devised for facilitating business transformation. While the state-of-the-art business transformation consulting models and methods are useful, there are a number of general problems that need to be addressed to make them more effective. First, the current approaches are often limited in scalability because they demand subject matter experts to work with a variety of disconnected data, tools, templates and other assets. It is often cumbersome and difficult to streamline the data gathering and management manually. Data and documents often reside in multiple folders distributed among several machines. Consistency checking across data can only be done manually, and the process requires experts. It is not easy to capture a structured thinking process without a tool, which enforces the process or method. Information and knowledge not captured systematically is often difficult to disseminate and reuse effectively. Assets such as knowledge, models and methods are not necessarily managed. For example, more often than not, there is no version control put in place, and updating the assets consistently across the board becomes a daunting task. Multiple views with scattered documents having multiple views such as a process view, metrics view, component view, resource view, etc. are difficult to visualize. This in turn makes it difficult to link up upstream and downstream analysis.

Business transformation is related to earlier efforts and studies in Business Process Reengineering, Business Process Redesign, Business Process Change Management, Business Process Management, and Enterprise Architecture. Business process reengineering (BPR) is a management approach aiming at improvements by means of elevating efficiency and effectiveness of the processes that exist within and across organizations. In BPR, organizations look at their business processes from an unbiased perspective and determine how they can best construct these processes to improve how they conduct business. In 1990s, process reengineering was adopted at an accelerating pace. The early BPR methodologies were rooted in IT-centric BPR solutions. One such model, Process Reengineering Life Cycle approach outlines an iterative application of the following steps: (1) envision new processes, (2) initiating change, (3) process diagnosis, (4) process redesign, (5) reconstruction, and (6) process monitoring. While useful in specific cases, the methodologies did not address issue of scalable applications from the practitioner's viewpoint. There are few tools or information technology that comprehensively facilitates the BPR methodology, and users are left with primitive means for practicing the methodology.

Business Process Management (BPM) is an emerging field of knowledge and research at the intersection between management and information technology, encompassing methods, techniques and tools to design, enact, control, and analyze operational business processes involving humans, organizations, applications, documents and other sources of information. BPM differs from BPR in that it does not aim at one-off revolutionary changes to business processes, but at their continuous evolution. In addition, BPM usually combines management methods with information technology to make business transformation activities faster and cheaper. BPM systems monitor the execution of the business processes so that managers can analyze and change processes in response to data, rather than just a hunch. BPM allows the organizations to manage their processes as any other assets and improve and manage them over the period of time. The activities which constitute BPM life-cycle can be grouped into five categories: Process Design, Process Modeling, Process Execution, Process Monitoring, and Process Optimization.

Another related concept is Enterprise Architecture, which is the description of the current and future structure and behavior of an organization's processes, information systems, personnel and organizational sub-units, aligned with the organization's core goals and strategic direction. Although often associated strictly with information technology, it relates more broadly to the practice of business optimization in that it addresses business architecture, performance management, organizational structure and process architecture as well. The primary purpose of creating enterprise architecture is to ensure that business strategy and IT investments are aligned. As such, enterprise architecture allows traceability from the business strategy down to the underlying technology. The practice of enterprise architecture involves developing an architecture framework to describe a series of “current”, “intermediate” and “target” reference architectures and applying them to align change within the enterprise. These frameworks detail all relevant structure within the organization including business, applications, technology and data. Each framework will provide a rigorous taxonomy and ontology that clearly identifies what processes a business performs and detailed information about how those processes are executed. While enterprise architecture is a key component of the information technology governance process at any organization of significant size, it also ideally relates broadly to the practice of business process management and optimization, because it addresses business architecture, performance management and process architecture as well.

U.S. Patent Publication 2005/0246215A1 discloses a system and method for alignment of an enterprise to component business model (CBM). This patent publication discloses creating a component business model of the enterprise in its current state and a component business model of a desired state, then comparing the two to identify the areas of improvement and change. The differences identified between the two are prioritized for alignment with business objectives.

U.S. Patent Publication 2007/0027701 discloses a system and method for using component business model to organize an enterprise. This patent publication discloses how a component business model can be used to organize an enterprise. It describes identifying non-overlapping components of a business and then distinguishing them based on whether each component helps differentiate the business in the marketplace or if it provided standardized functions. One can analyze the attributes of each component and mark components as ‘hot’, meaning they might need to be optimized to align to the business objectives.

U.S. Patent Publication 2007/0174109 discloses a system and method for transforming an enterprise using a component business model. This patent publication describes a system and a method of using a CBM map for transforming an enterprise. Specifically, it discloses that industry standard CBM maps can be prepared ahead of time for each industry and that these can be retrieved from a repository and customized for each client's need. Components in a CBM can be rearranged based on the transformation strategy chosen. Special views can be enabled on a CBM map to query and focus on specific components related to a specific capability.

U.S. Patent Publication 2008/0033888 discloses a method and system for enterprise portfolio management based on component business model. This patent publication describes managing a portfolio of enterprise IT applications based on component business model. The idea is to help select a suitable set of IT transformation projects from among a larger set of IT transformation projects by conducting value analysis. This value analysis keeps the existing IT infrastructure of the client into account.

The above described patent publications, however, do not disclose or suggest identification of business transformation initiatives automatically, conducting a business case analysis of the transformation initiatives identified via component business modeling analysis, for instance, including return on investment (ROI) calculation, net present value (NPV) calculation, break-even analysis, internal rate of return (IRR), etc. Those publications also do not disclose or suggests pre-populating the tool with various industry specific content (such as metrics, costs of transformations etc) based on past history, or providing what-if scenario analysis for evaluating several transformation initiatives, thereby facilitating the selection of best suited set of transformations from a portfolio of transformation choices possible. They also do not disclose or suggest automation of health measurement of each component by comparing the metrics associated with a component with those of industry benchmarks.

### BRIEF SUMMARY OF THE INVENTION

A method and system for determining temperature of one or more business components are provided. The method, in one aspect, may comprise determining temperatures for metrics associated with a business component using benchmark data; aggregating the temperatures for metrics using a selected algorithm to determine a representative temperature for the business component; providing a spectrum of colors to represent the range of temperatures; and presenting the representative temperature as a color from the spectrum of colors.

A system for determining temperature of one or more business components, in one aspect, may comprise a computer-implemented module operable to determine temperatures for metrics associated with a business component using benchmark data, the temperature being a degree to which a metric is associated with one or more business strategies and/or pain points; a computer-implemented module operable to aggregate the temperatures for metrics using a selected algorithm to determine a representative temperature for the business component; a computer-implemented module operable to provide a spectrum of colors to represent the range of temperatures; and a computer-implemented user interface module operable to present the representative temperature as a color from the spectrum of colors.

A program storage device readable by a machine, tangibly embodying a program of instructions executable by the machine to perform above-describe methods may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates aggregating metrics temperature to determine temperatures of business components.

FIG. 2 is an overview of a business transformation (BT) tool environment in one embodiment of the present disclosure.

FIG. 3 is an example of a model template provided in the present disclosure in one embodiment.

FIG. 4 illustrates a daisy chain model in one embodiment of the present disclosure.

FIG. 5 shows a model mapping editor in one embodiment of the present disclosure.

FIG. 6 illustrates a component business model rendered in BT tool of the present disclosure in one embodiment.

FIG. 7 illustrates a graphical user interface that enables daisy chain analysis in one embodiment of the present disclosure.

FIG. 8A illustrates business component visualization that utilizes an algorithm referred to as “at least one.”

FIG. 8B illustrates business component visualization that utilizes an algorithm referred to as “all” algorithm.

FIG. 8C illustrates business component visualization that utilizes an algorithm referred to as “majority without weights.”

FIG. 9 shows an example of a CBM map showing the result of a Business Component Performance Analysis.

### DETAILED DESCRIPTION

The following terms are used in the present disclosure and explained below.

Business process: A business process is a flow of one or more business activities. A business process when executed accomplishes a specific business objective. For example, ‘Process accounts payable and expense reimbursements’ is a typical business process in the finance management domain.

Business activity: A business activity is the lowest level task in a business process. For example ‘Accounts Payable’ business process contains activities such as: ‘Approve Payments’, ‘Process taxes’, ‘Retain records,’ etc.

A business component: A business component is an abstract business element. It is a collection of similar and related business activities from various business processes. From this point of view, business processes can be thought of as flows of activities between and within components. A component is defined by a set of people, processes and technology needed by its business function. For example, ‘Accounts Payable Processing’ is a business component, and the ‘Process accounts payable and expense reimbursements’ business process may contain activities involved in the ‘Accounts Payable Processing’ component. A business component enables business processes.

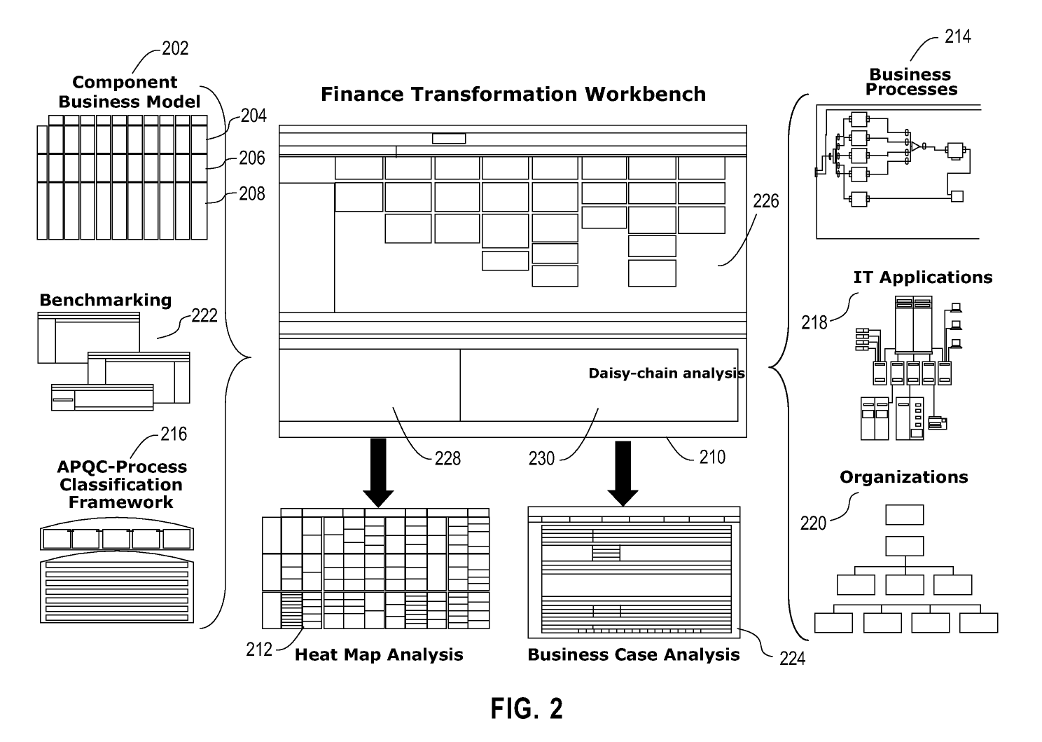

Component Business Model (CBM): Component business model is a method developed by IBM™ to help analyze clients' business from multiple perspectives such as people, process and technology. The intersection of these views offer improved insights for decision-making. A CBM is a component view of a business where all the similar business activities of a given company's business processes are grouped into components. A sample component business map of a fictitious company is shown in FIG. 2 at 202. It is represented as a two dimensional matrix: The columns are created after analyzing a business's functions, competencies, and value chain. The rows are defined by actions and their accountability levels. The top row, “direct,” represents all those components in the business that set the overall strategy and direction for the organization. The middle row, “control,” represents all the components that translate those plans into actions, in addition to managing the day-to-day operation of those activities. The bottom row, “execute,” contains the business components that actually execute the detailed activities and plans of an organization. The “Component Business Map” shows activities across lines of business, without the constrictions of geographies, internal silos or business units. The component business map for a company is typically represented on a single page. Maps of companies in an industry sector may be similar, but those of different industries may be drastically different.

A system and method of the present disclosure aid in automating component performance analyses, for example, by automatically comparing the metrics that help measure the performance of a component with benchmark data. This is also referred to as ‘heat map’ analysis. Business metrics refer to parameters or factors that affect business or those that may be used to measure business.

The Business Component Performance Analysis allows the user to discover one or more components that are associated with one or more business strategies and/or pain points. Those components are herein referred to as “hot” components. A pain point is an area where a company is noted to be underperforming in comparison to its peers or industry leaders or expectations set by the company or combinations thereof. In the traditional CBM analysis, this step was conducted manually by the business consultants relying on knowledge and expertise in the business domain. In the traditional component business modeling (CBM) analysis, this step was conducted manually by the business consultants relying on his/her knowledge and expertise in the business domain. The method and system of the present disclosure automate the capability as visual queries, by taking metrics values into account with the analysis. The system allows the user to explore a value driver tree to identify one or more value drivers that may be associated with a certain business strategy/pain point. The Value Driver tree is a hierarchical representation of Key Performance Indicators (KPI) of business processes. At the lowest level, it provides business metrics, which are used to measure the performance of low level business activities of the Business Process Hierarchy. The Value Driver tree may also include attribute values such as one or more benchmark values and the business' current value associated with those metrics. The low level metrics are grouped to one or more higher level indicators. At the highest level of the Value Driver tree, the indicators are grouped into financial metrics of enterprises such as cost, revenue, profit, share value, etc.

The discovery of “hot” components that affect the business strategy can be accomplished, for instance, as follows.

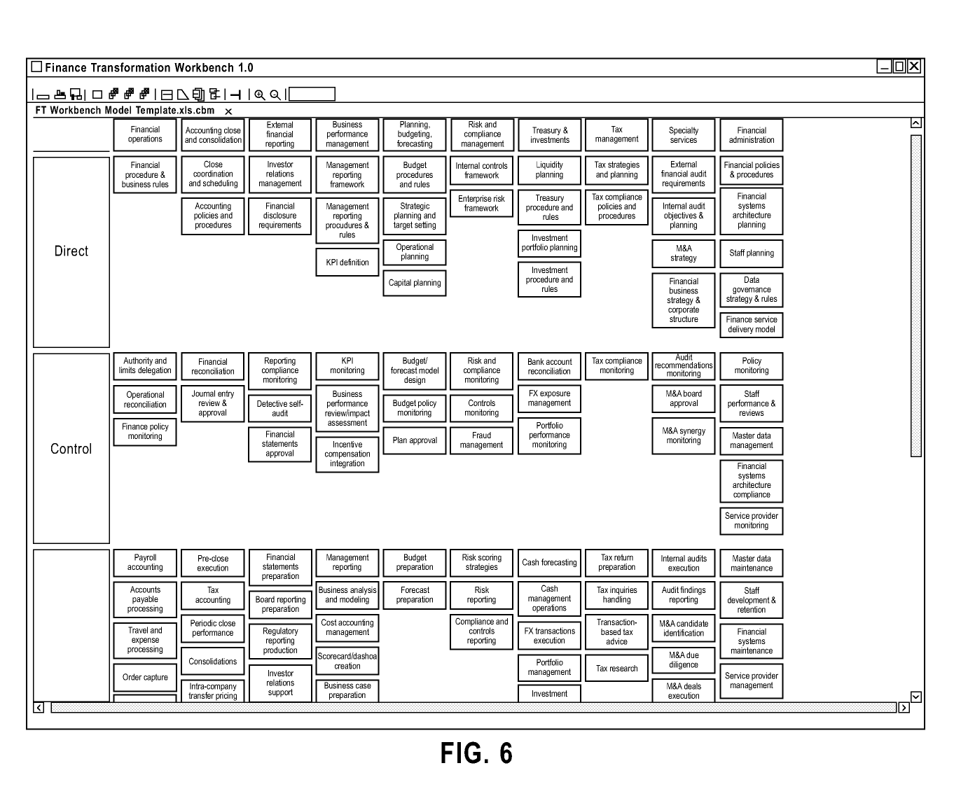

FIG. 2 is an overview of a business transformation (BT) tool environment in one embodiment of the present disclosure. In this disclosure, Financial Transformation (FT) is also referred to as Business Transformation (BT). BT tool of the present disclosure provides an integrated view of various business models and data, for example, including component business models 202, a business process model such as APQC (American Product Quality Council) Process Classification Framework (PCF) 216 and SAP Business Process Hierarchy (BPH), a value driver model an IT infrastructure map 218, an organization structure map 220, and a solution catalog, with the models linked each other. Another example of component business model (202) is shown in fuller view in FIG. 6. BT tool environment in one embodiment of the present disclosure automates traditional component business model-based analyses in the form of visual queries and inference in one embodiment. For example, one can ask questions such as which metrics help measure the performance of a given business component? What are the IT systems that support the business functions represented by a business component? Which organizations implement the business functions represented by a business component? Which transformation solutions can address a given shortfall? These questions are answered in the tool via the explicit and the inferred linkages made among different models such as the component model 202, IT system model 218, organizational model 220, metrics model 222, business processes model 214, etc. This is also referred to as daisy chain analysis in the tool.

The BT tool of the present disclosure automates the component performance analysis by comparing the metrics that help measure the performance of a component with benchmark data 222. This is referred to as “heat map” analysis in the tool. An example view of a heat map is shown at 212. The underperforming components can be marked as shortfalls based on whether it is caused by a misaligned IT system or by an organization. This identification and marking of shortfalls is referred to as “shortfall assessment” in the tool. The tool provides business benefit analyses in terms of value drivers and standard financial metrics for business case analysis 224 such as NPV (Net Present value), IRR (Internal Return Rate), ROI (Return on Investment), and payback time. The BT tool provides normative and constructive business performance analysis models, so it can be easily configured for different types of clients, initiatives, and projects.

In one embodiment, BT tool may provide views of enterprise CBM maps 226, value drivers 228, and business activities 230 and provides navigation through all of them. It enables analysts to navigate the views and identify dependencies and causal relationships among value drivers 228 and business activities 230 and components 226. It also enables analysts to pinpoint business activities and value drivers supported and improved by solutions and services. It provides detailed value driver reports with charting generated by advanced value modeling. Also, it provides detailed financial analysis reports with charting generated by advanced value modeling.

BT tool of the present disclosure may comprise a Model Template, which may be an Excel™ file providing a template for data preparation and storage for analyses; Transformation Analyzer, which may be a Windows™ application where the user can explore various model views, conduct CBM-based analyses, and identify transformation initiatives for proposal; and Business Case Calculator, which may be an Excel™-based tool where the user can perform business case analysis for the initiatives identified in the Transformation Analysis. These three components may be seamlessly connected to each, and so the user can move back and forth among the components in a straightforward manner. Details of various functionalities of the BT tool are described below.

### Model Template

To run business transformation analyses in the system, a set of models and content are prepared following a set of rules. The content preparation can be done by using the provided Model Template, which may be an MS Excel™ file or another spreadsheet application or like, with formatting for the content. The content preparation may include preparing the base models, for example, the six base models. The six base models, for instance, include models for Business Component, Business Process, Value Drivers, Applications, Organizations, and Solutions. The content preparation also includes linking or mapping these base models. Model mapping is described in further detail below.

In one embodiment of the BT tool, content for the base models (e.g., the six base models) are provided in six separate worksheets in the Model Template: one model in each worksheet—Business Component, Business Process, Value Drivers, Applications, Organizations, and Solutions. The BT tool may include a set of sample content for each of the base models (e.g., the model templates populated with initial or default data), for example, derived from available benchmark data, such as APQC, IBM Benchmarking data, and solution and service offering catalogs. Data entries such as metric may have a set of attributes, which may be used in various analyses.

In one embodiment, the Business Component worksheet provides a tabular representation of a CBM map. Business components are grouped by their competencies and each component has its accountability level, i.e., direct, control or execute, as an attribute.

The Business Process worksheet in one embodiment provides a hierarchical representation of a business process structure, e.g., APQC PCF (Process Classification Framework), SAP BPH (Business Process Hierarchy), or IBM EPF (Enterprise Process Framework).

The Value Driver worksheet in one embodiment provides a hierarchical representation of Key Performance Indicators (KPI) of business processes. At the lowest level, it provides business metrics, which are used to measure the performance of low level business activities of the Business Process Hierarchy. The Value Driver worksheet may be pre-populated with one or more attribute values such as one or more benchmark values and the business' current value. The low level metrics are grouped into one or more higher level indicators. At the highest level of the Value Driver tree, the indicators are grouped into financial metrics of enterprises such as cost, revenue, profit, share value, etc.

The Applications worksheet in one embodiment provides a hierarchical representation of the IT infrastructure and applications the enterprise or entity is currently deploying. This information is used in one embodiment of the method and system of the present disclosure to understand where the enterprise stands, and identify any shortfalls in terms of IT.

The Organizations worksheet provides a hierarchical representation of the human resources and organizations the enterprise currently employs. This information is used in one embodiment of the method and system of the present disclosure to understand where the enterprise stands, and identify any shortfalls in terms of human resources and capital.

The Solutions worksheet provides a hierarchical representation of solutions that may address identified shortfalls in business process, IT, data, and human organization. The solution may be software, services and their combinations. A solution does not have to be complete when offered. Instead, it may be composed and designed on demand to address a specific shortfall that is identified.

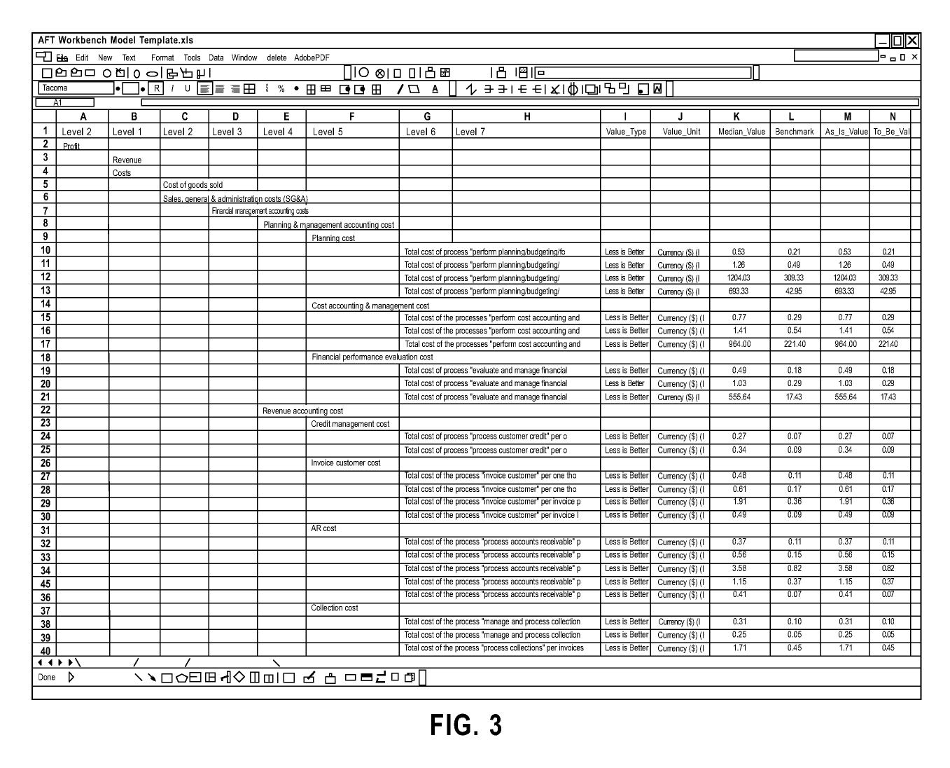

In one embodiment each model includes data structured in a tree format or view. FIG. 3 shows an example of the value driver tree in the Model Template with metrics attributes such as value type (column I), value unit (column J), benchmark value (column L), median value (column K), as-is value (column M) and to-be value (column N). The as-is value is the current value of the particular metric of the current business, i.e., where the business stands. The to-be value is the target value of the metric the business wants to achieve by applying one or more solutions, i.e., where the business wants to go. The benchmark and median values are reference values. For instance, the benchmark value may be a standard value for instance in the similar industry, and median value may be a median of all standard values, or like. They are compared with the as-is and target values to understand where the business stands and where the business wants to go in the group of peer enterprises. For example, if the as-is value is worse than the benchmark value, i.e., the best practice value among peer companies, the decision makers will want to improve it to the benchmark value level. That is, the to-be value will be the benchmark value. In one embodiment, the model content is generically in a tree form. As long as the structure is maintained, the user can add, delete and modify instances in the tree. In one aspect, a model worksheet may be named after the model that will be in it.

### Model Mapping

In one embodiment of the BT tool of the present disclosure, models are mapped to each other. This linking enables the capability to answer various queries. This linking of models and the ability to query them are also referred to herein as “Daisy-Chain analysis.” With binary mapping of models, the system infers correlations across multiple models, which provides qualitative understanding on how models are related. For example, with the daisy-chain analysis, the user can see all the business processes and activities that are associated with a business component. In turn, the user can see all the metrics (along with their values) and value drivers of the selected business processes, and so the user can qualitatively see the overall performance of the component.

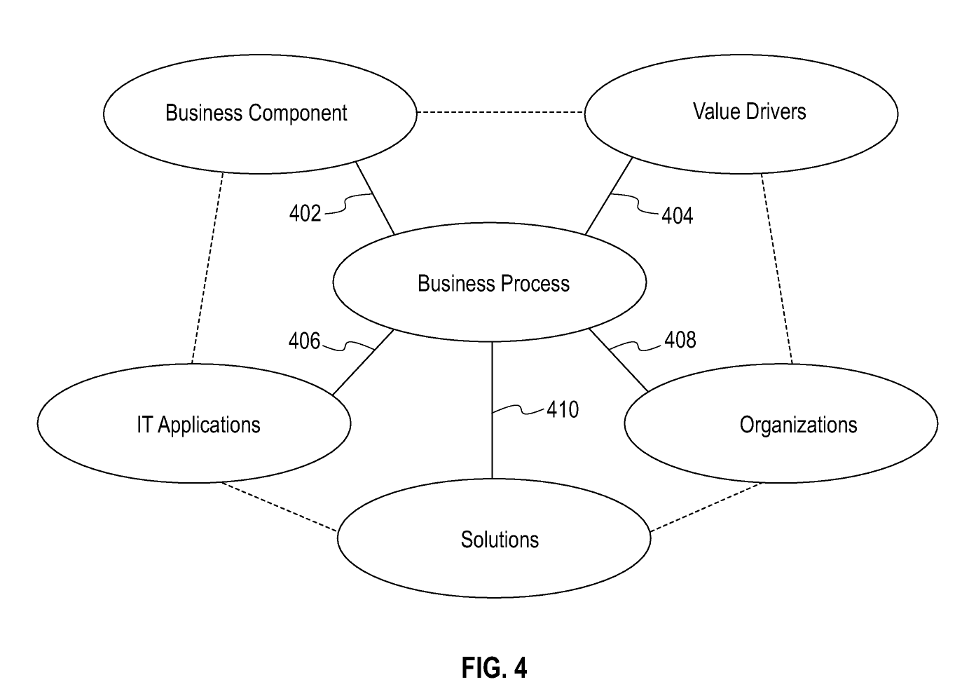

FIG. 4 illustrates daisy chain of models in one embodiment of the present disclosure. For the six base models, the user may provide initial model mapping to Business Processes in the Model Template file, e.g., five types of links, i.e., Comp2BizProc 402, VD2BizProc 404, App2BizProc 406, Org2BizProc 408, and Sol2BizProc 410. In one embodiment, the BT tool uses a hub-and-spoke approach to linking of models, i.e., all models are linked to the business process model instead of each model linking to each other model as shown in FIG. 4. Each model mapping is stored in a separate mapping worksheet bearing the mapping name. The Model Template file provides a set of sample model mapping in the mapping worksheets. For instance, each mapping type has a worksheet. The mapping may be done manually by subject matter experts or business consultants. The mapping is used for the daisy-chain analyses. The explicit mappings stored in the mapping worksheets are used to infer implicit relationships among models in the daisy-chain analyses. The user can add, delete, modify instances in the mapping worksheets by changing entries in the source cell and target cell columns. If the user does not want to create model mapping information at this stage, the user may remove the provided sample data in the mapping worksheets (or worksheets themselves). This model mapping information in this file is optional, and not required to run the tool for analyses.

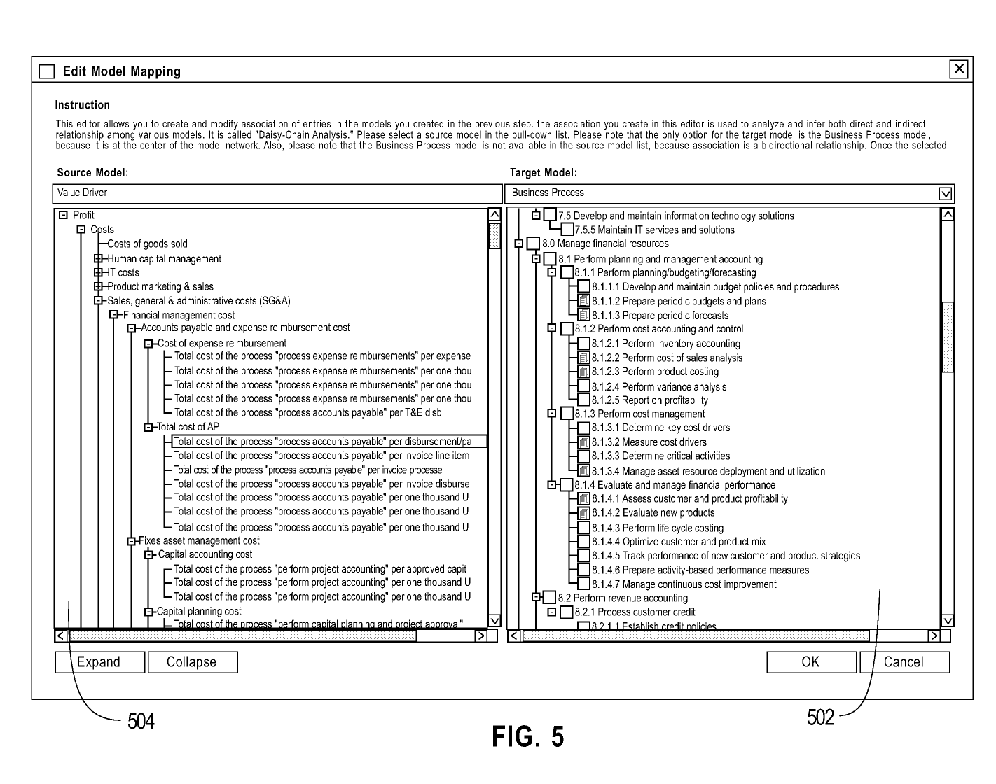

The BT tool additionally may provide a user interface, e.g., Model Mapping Editor, for creating model mappings. Additional model mapping created with the editor may also be added to the Model Template file, when saved in BT tool. FIG. 5 shows the graphical user interface (GUI) editor for model mapping. It allows the user to select a source model and a target model. On the source side mappings are to be made from the leaf nodes, i.e., nodes with no child nodes. All other nodes of the tree are grayed out. The target model in one embodiment is always the business process model. The model mapping editor also provides tree views of the selected source and target models. In the tree view, the user can map entries in the source and the target models by using check-boxes and buttons. The editor may be implemented using programs such Visual Basic™ or other programming languages.

The BT tool of the present disclosure in one embodiment allows mappings to be made to all levels of the business process tree. FIG. 5 at 502 shows an example of a business process. For example, “8.0 Manage Financial Resources” is a business process. It includes multiple subgroups, i.e., 8.1, 8.2, . . . , and multiple levels, i.e., 8.0=>8.1=>8.1.1=>8.1.1.1, as shown in the window 502. Mappings are allowed to be made at all levels of the business process tree mainly to deal with mappings between metrics and business processes. For instance, in FIG. 5, a metric in Value Driver tree 504, e.g., “Total cost of account payable process” can be mapped to a business process at any level of the Business Process tree 502, e.g., 8.0, 8.1, 8.1.1, or 8.1.1.1. Metrics as used herein refer to quantitative measures that indicate the performance of the business process. There may be metrics for all levels of business process. For example, benchmarking wizard tools may have measures and metrics at process level, at process group level. There may be metrics even at the process category level. The Model Mapping Editor allows the user to capture such mappings. In one embodiment, the BT tool does not allow for the same kind of possibility from the source side because opening up the entire tree on both sides could create possibilities for redundant mappings and sometimes even conflicting mappings. To avoid any confusion and redundancy in mappings, the source side opens for mapping only at the leaf node level whereas on the target side mappings are allowed to be made at all levels.

All the mappings in one embodiment of the present disclosure are bi-directional, meaning A is mapped to B, and then B is mapped to A automatically. In order to avoid duplication in mapping, the target model may be fixed to Processes. Every model (source) may be mapped to Process (target). However, Process is not mapped to any model manually. Instead, that part is implied by the first mapping. The mapping or associations made to children get propagated up to the parent but not vice versa in one embodiment. If a component is mapped to a process, it is not assumed that the component implements all activities in that process. For this reason, the BT tool in one embodiment does not propagate process level mappings down to activities.

The prepared content in the Model Template file, for instance, a spreadsheet file such as an Excel™ file is parsed and validated by the BT tool. If the content does not follow the required format set by the rules, a functional module in the BT Workbench such as data validating program, generates error messages to help the user repair the format of content.

### Transformation Analyzer

The Transformation Analyzer component of the BT tool in one embodiment provides the following analysis capabilities, although the Transformation Analyzer's functionalities need not be limited to only those listed here: Daisy-Chain Analysis; Business Component Performance Analysis (also referred to as Heat Map Analysis); Shortfall Assessment for both IT application and organization; Solution Analysis; Business Report Generation, for instance, in MS Excel™ and PowerPoint™.

Component Business Modeling described above is a novel business modeling technique from IBM™, which enables users to understand and transform businesses. A component business model represents the entire business in a simple framework that fits on a single page. It is an evolution of traditional views of a business, such as ones through business units, functions, geography, processes or workflow. The component business model methodology helps identify basic building blocks of business, where each building block includes the people, processes and technology needed by this component to act as a standalone entity and deliver value to the organization.

After a comprehensive analysis of the composition of each business, a user can map these individual building blocks, or components, onto a single page of a user interface screen, for example as shown at 226 in FIG. 2. Each component business map may be unique to each company. The columns are created after an analysis of a business's functions and value chain. The rows are defined by actions. FIG. 2 at 202 shows an example of a Component Business Model map rendered in the BT tool. The top row, “direct,” 204 shows all of those components in the business that set the overall strategy and direction for the organization. The middle row, “control,” 206 represents all of the components in the enterprise, which translate those plans into actions, in addition to managing the day-to-day running of those activities. The bottom row, “execute,” 208 contains the business components that actually execute the detailed activities and plans of an organization. The component business map shows activities across lines of business, without the constrictions of geographies, internal silos or business units.

This single page perspective 226 provides a view of the business, which is not constricted by barriers that could potentially hamper the ability to make meaningful business transformation. The component business model facilitates to identify which components of the business create differentiation and value. It also helps identify where the business has capability gaps that need to be addressed, as well as opportunities to improve efficiency and lower costs across the entire enterprise.

The “Daisy-Chain Analysis” is a visual query that allows the user to explore the business maps and understand the correlations and dependencies among business entities. The results of the query are shown in the views 210 of the models in the BT tool highlighting entries in the models that are associated directly and indirectly. For example, this capability can interactively identify one or more business components associated with a particular value driver. Conversely, it can find one or more value drivers that are affected by the performance of a particular business component. The associations between value drivers and business components are discovered through their relationships with business processes and activities set by using the Model Mapping Editor. Similarly, BT tool can identify and show dependencies between business activities and IT applications, and also between business activities and solutions and initiatives, both IT and business-driven.

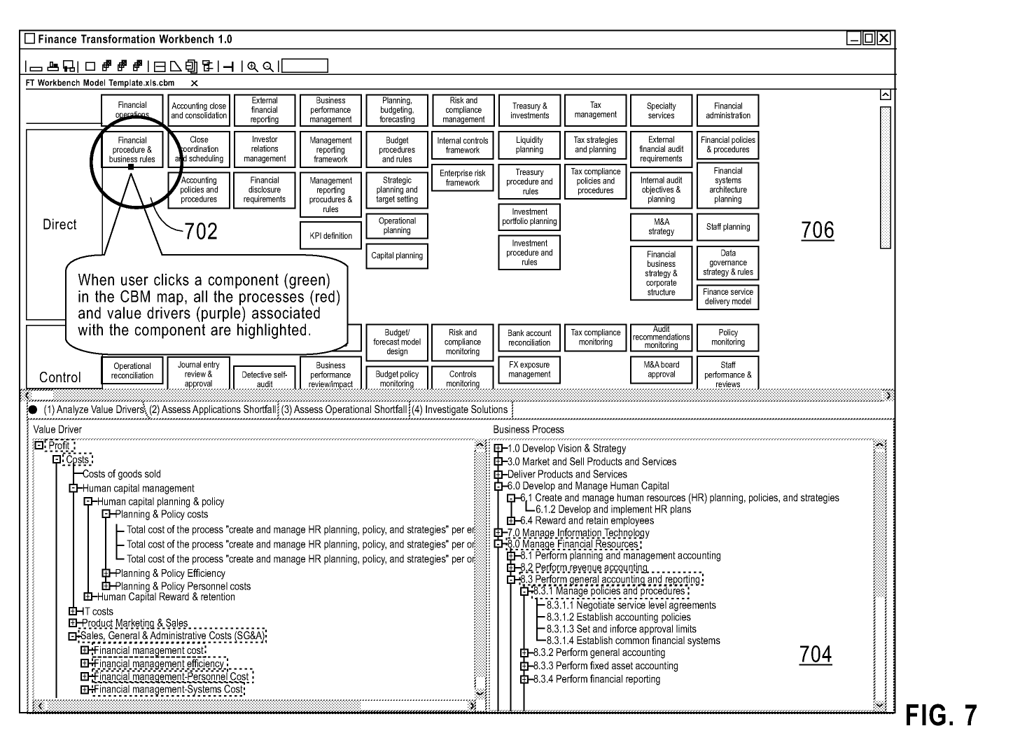

The relationships are transitive, and so it is possible to infer indirect associations between value drivers and IT applications/solutions, also between components and IT applications/solutions, and so on, through their direct linkages with entries in the business process model. Also, transitivity is used in inferring indirect relationship to ancestor entries when there is a direct relationship set for a child in a tree structured model. FIG. 7 shows an example of a user interface that includes a business component model 706 built from a template and Daisy-Chain Analysis 704 when a business component, “Financial Procedures & Business Rules” is selected, for example, by clicking on the box 702. The BT tool highlights all the business processes directly linked to the component, and also highlights all the metrics and value drivers indirectly linked to the component through those highlighted business processes. The user can see attribute values such as the as-is value and benchmark value by a mouse-over operation. To support the Daisy-Chain Analysis, the BT tool captures the basic relationship information in the Model Template file and also linkages set up with Model Mapping Editor.

The Business Component Performance Analysis allows the user to discover one or more “hot” components that are associated with one or more business strategies and/or pain points. A pain point is an area where a company is noted to be underperforming in comparison to its peers or industry leaders or expectations set by the company or combinations thereof. In the traditional CBM analysis, this step was conducted manually by the business consultants relying on knowledge and expertise in the business domain. The BT tool of the present disclosure automates the capability as visual queries, by taking metrics values into account with the analysis. The BT tool allows the user to explore the value driver tree. The Value Driver tree is a hierarchical representation of Key Performance Indicators (KPI) of business processes. At the lowest level, it provides business metrics, which are used to measure the performance of low level business activities of the Business Process Hierarchy. The Value Driver tree may also include attribute values such as one or more benchmark values and the business' current value associated with those metrics. The low level metrics are grouped to one or more higher level indicators. At the highest level of the Value Driver tree, the indicators are grouped into financial metrics of enterprises such as cost, revenue, profit, share value, etc.

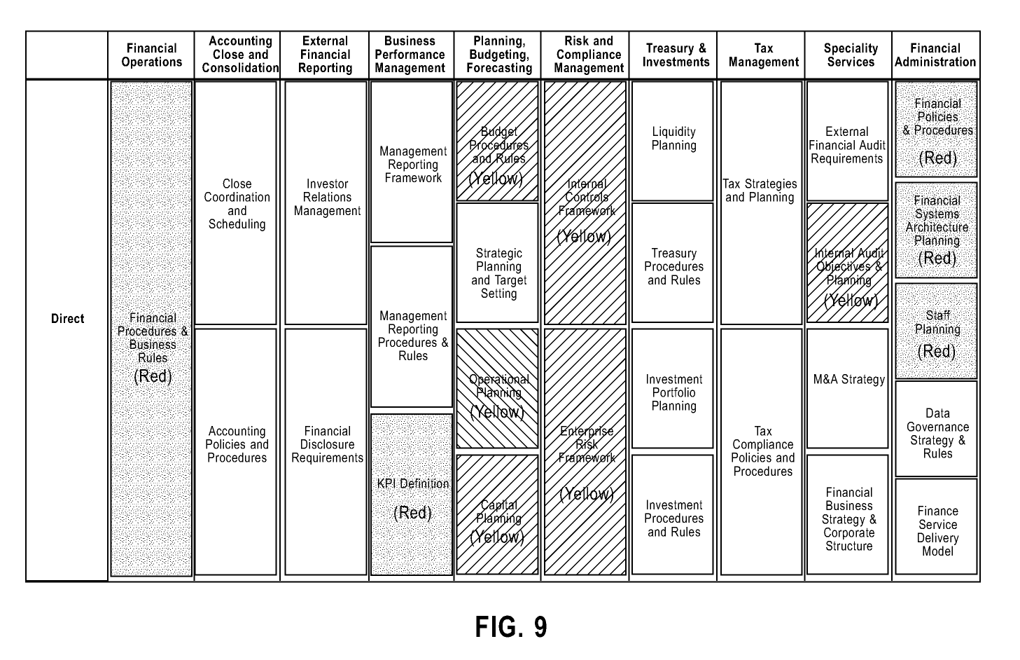

Using the value driver tree, one or more value drivers can be identified that may be associated with a certain business strategy/pain point. The discovery of “hot” components that affect the business strategy can be accomplished. Various visualization techniques may be employed, for example, coloring the identified hot components differently to distinguish ones that affect positively or negatively to the strategy. The BT tool system compares the industry benchmark and the as-is value of the operational metrics and performance indicators associated with the components to decide on their color. FIG. 9 shows an example of a CBM map showing the result of a Business Component Performance Analysis.

An algorithm for coloring business component in the Business Component Performance Analysis is as follows: The BT tool system compares the three values—as-is (from client), benchmark, and median values of each metric associated with each business component Benchmark and median values may be obtained from available benchmarking tools, benchmark data repositories, etc. For example, APQC provides sets of benchmark data for fee. Benchmark data may be also obtained from tools that survey and collect metrics value of a plurality of business processes from a plurality of members and/or customers. The data is then analyzed statistically. For example, the benchmark value of a metric is the 90 percentile value. The median value is the 60 percentile value, etc. If necessary, there can be more than one value like benchmark and median for comparisons. The business component is colored green, if the as-is value of each and every metric associated with this component is better than the corresponding benchmark value. The business component is colored yellow, if it has at least one metric whose as-is value is better the median value but worse then the benchmark value, and all the other metrics have as-is value, which is better than the benchmark value. The business component is colored red, if it has at least one metric whose as-is value is worse then the median value. The notion of “being better” compares differently for different metric value types: For the “Less is Better” type: A is better, if A<B. However, for the “More is Better” type: A is better, if A>B.

Depending on analysis needs, there may be many variants of the component color coding algorithms for the Business Component Performance Analysis. The following algorithms may be utilized:
AT LEAST ONE: The Business Component Performance Analysis engine identifies all the business components associated with the current value driver, and discovers ones at least one of whose associated metrics has the as-is value worse than the benchmark value; the engine colors the components red, while coloring the other components green. This algorithm is most aggressive in identifying “hot” components.
ALL: This algorithm is at the other end of the spectrum of Business Component Performance Analysis algorithms. It is most generous in identifying “hot” components. The Business Component Performance Analysis engine discovers business components all of whose associated metrics have the as-is value worse than the benchmark value; the engine colors the components red, while coloring the other components green.
MAJORITY without weights: This algorithm is in the middle of the spectrum. The Business Component Performance Analysis engine discovers business components more than half of whose associated metrics have the as-is value worse than the benchmark value; the engine colors the components red, while coloring the other components green.
MAJORITY with weights: This algorithm assumes some weight value assigned to each metric. Also, it assumes a threshold value that compared to a component's “heat” value. The heat value of a component is computed by applying the difference of as-is values and benchmark values of associated metrics and their weights. Depending on how the equation is formulated, this algorithm can provide various results. This can be a generic algorithm for the three special cases above.

A spectrum of colors may be used to indicate the results of the performance analysis. More colors can be added (in addition to red and green) to represent the “heat” degree (“temperature”) of components. One example is the use of yellow in FIG. 9 to indicate the mediocre performance between red and green.

The system and method may color the identified hot components differently to distinguish those that affect positively or negatively to the strategy. For example, high performance components that positively affect the implementation of the business strategy of the company and low performance components that negatively affect the implementation of the business strategy of the company may be represented differently for easy visualization. Other visualization mechanisms may be employed. The system and method in one embodiment may compare the industry benchmark and the as-is value of the operational metrics and performance indicators associated with the components to decide on their color. FIG. 9 shows an example of a CBM map showing the result of a Business Component Performance Analysis.

An algorithm for coloring business component in the Business Component Performance Analysis is as follows: The system and method of the present disclosure may compare the three values—as-is (from client), benchmark, and median values of each metric associated with each business component. Benchmark and median values may be obtained from available benchmarking tools, benchmark data repositories, etc. For example, American Product Quality Council (APQC) provides sets of benchmark data for fee. Benchmark data may be also obtained from tools that survey and collect metrics value of a plurality of business processes from a plurality of members and/or customers. The data is then analyzed statistically. For example, consider an example where the benchmark value of a metric is the 90 percentile value; the median value is the 60 percentile value, etc. More than one values of benchmark and median values may be used in the comparisons. As an example of visualization, the business component is colored green, if the as-is value of each and every metric associated with this component is better than the corresponding benchmark value. The business component is colored yellow, if it has at least one metric whose as-is value is better the median value but worse then the benchmark value, and all the other metrics have as-is value, which is better than the benchmark value. The business component is colored red, if it has at least one metric whose as-is value is worse then the median value. The notion of “being better” compares differently for different metric value types: For the “Less is Better” type: A is better, if A<B. However, for the “More is Better” type: A is better, if A>B.

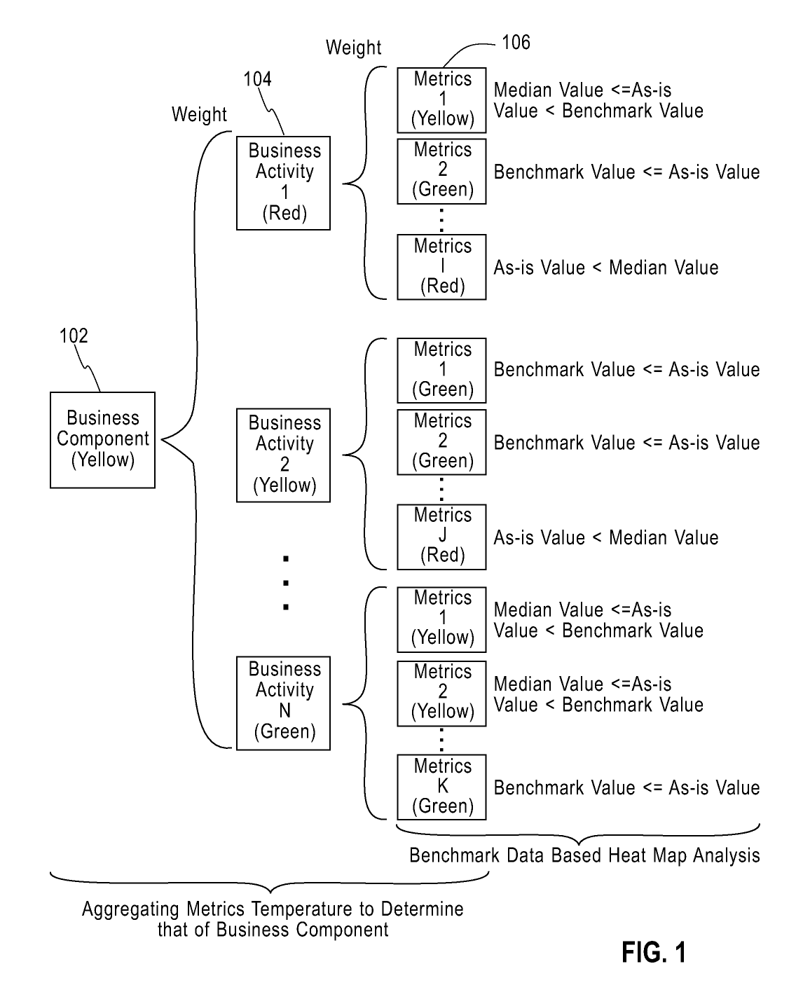

FIG. 1 illustrates an example of aggregating temperatures of metrics to determine temperatures of business components. Temperature of a business component herein refers to a degree to which the component is associated with one or more business strategies and/or pain points. A pain point is an area where a company is noted to be underperforming in comparison to its peers or industry leaders or expectations set by the company or combinations thereof. Shown at 106, business metrics are color coded based on how their values compare with the benchmark values or like. Those metrics are then aggregated to determine the temperature of the business activity associated with those metrics as shown at 104. Similarly, the determined temperatures of the business activities are aggregated as shown at 102 to determine the temperature of the business component.

Color codes or temperatures of metrics 106 may be determined based on various algorithms and values. For example, if the as-is value of a metric is better than equal to a median value but not as good as the benchmark value, that metric may be determined to have a medium temperature, e.g., color coded yellow. If the as-is value of a metric is better the benchmark value, that metric may be determined to have a low temperature, e.g., color coded green. If the as-is value of a metric is worse than the benchmark value and the median value, that metric may be determined to have a high or hot temperature, e.g., color coded red. Other algorithms and/or other comparison values may be used to determine the temperatures of metrics.

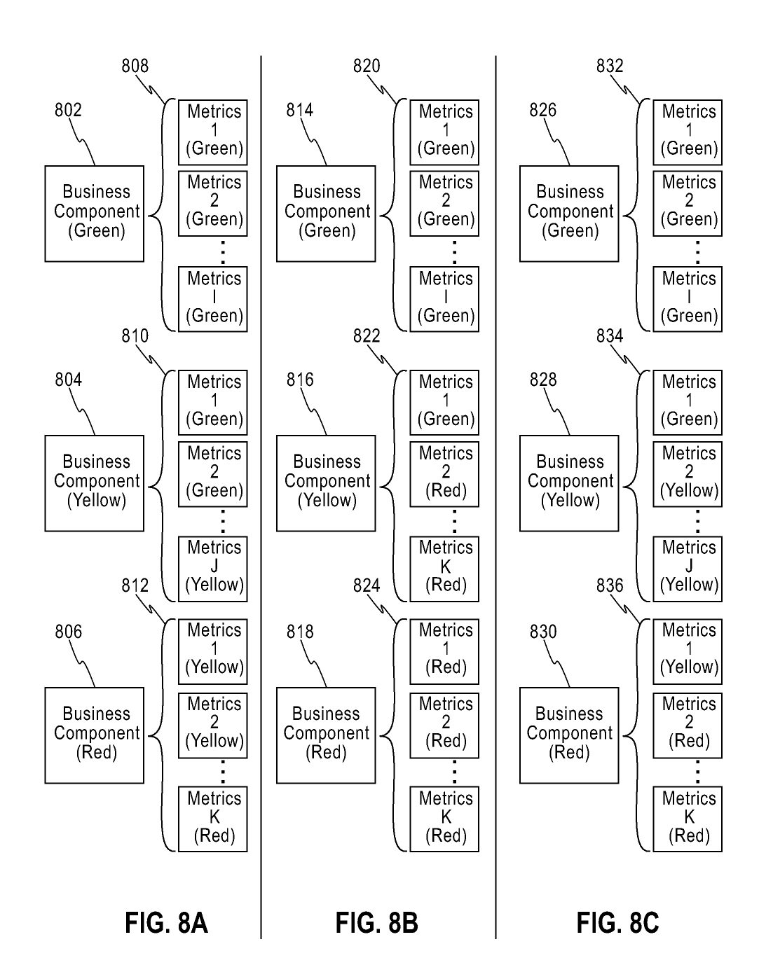

Depending on analysis being performed, there may be many variants of the component color-coding algorithms for the Business Component Performance Analysis. FIG. 8A illustrates an algorithm referred to as “at least one”. This algorithm may be considered as most aggressive (or pessimistic) in identifying “hot” components. In this algorithm, if a business component has at least one of whose associated metrics has the as-is value worse than the benchmark value, that business component is identified “hot”. Color coding may be used to color the identified components as determined by comparing the metrics values. Business component at 802 is color coded green because all of its metrics 808 are green. That is, the component is colored green if all the metrics are green, there is no yellow metric, and there is no red metric. Business component at 804 is color coded yellow because at least one of its metrics 810 is yellow. That is, the component colored yellow if there is at least one yellow metric, all the others are green, and there is no red metric. Business component at 806 is color coded red because at least one of its metrics 812 is red. That is, the component is colored red if there is at least one red metric. This color-coding algorithm is considered the most pessimistic because the overall performance of a business component is determined by the worst performing business activity and its metric.

FIG. 8B illustrates an algorithm referred to as “all” algorithm. This algorithm represents most generous (or optimistic) in identifying “hot” components. In this algorithm, if a business component has all of whose associated metrics have the as-is value worse than the benchmark value, that business component is identified “hot”. Color coding may be used to color the identified components as determined by comparing the metrics values. A business component 814 is colored green if there is at least one green metric as shown at 820. A business component 826 is colored yellow if there is at least one yellow metric, all the others are green, and there is no red metric as shown at 822. A business component 818 is colored red if all the metrics are red, there is no yellow metric, and there is no green metric as shown at 824. This color-coding algorithm is considered the most optimistic because the overall performance of a business component is determined by the best performing business activity and its metric.

FIG. 8C illustrates an algorithm referred to as “majority without weights.” This algorithm is in the middle of the spectrum between the optimistic and pessimistic algorithms described above. Business components more than half of whose associated metrics have the as-is value worse than the benchmark value are identified as “hot”. The discovered components are colored red, while coloring the other components green. A business component 826 is colored green if the number of green metrics is greater than that of yellow metrics and that of red metrics as shown at 832. A business component 828 colored yellow if the number of yellow metrics is greater than that of green metrics and that of red metrics as shown at 834. A business component 830 is colored red if the number of red metrics is greater than that of green metrics and that of yellow metrics combined as shown at 836.

Another algorithm, referred to as majority with weights assumes a weight value assigned to each metric. Also, it assumes a threshold value that is compared to a component's “heat” value. The heat value of a component is computed by applying the difference of as-is values and benchmark values of associated metrics and their weights. Depending on how the equation is formulated, this algorithm can provide various results. This can be a generic algorithm for the three special cases above.

The following provides an example of the majority with weights algorithm.

Benchmark value threshold:

$$G = \frac{{\sum }_{i = 1}^{n} {w}_{i} g}{{\sum }_{i = 1}^{n} {w}_{i}}$$

Median value threshold:

$$Y = \frac{{\sum }_{i = 1}^{n} {w}_{i} y}{{\sum }_{i = 1}^{n} {w}_{i}}$$

As-is value:

$$X = \frac{{\sum }_{i = 1}^{k} {w}_{i} g {\sum }_{i = 1}^{l} {w}_{i} y {\sum }_{i = 1}^{m} {w}_{i} r}{{\sum }_{i = 1}^{k} {w}_{i} {\sum }_{i = 1}^{l} {w}_{i} {\sum }_{i = 1}^{m} {w}_{i}}$$

Where,

wi is weight assigned to metric, mi

g is constant value for a green metric

y is constant value for a yellow metric

r is constant value for a red metric

n is the total number of metrics

k, l, and m are the number of green, yellow, and red metrics, respectively

n=k+l+m

The component is colored green if G<=X

The component colored yellow if Y<=X<G

The component colored red if X<Y

In another aspect, the spectrum of colors may be used to indicate the results of the performance analysis. More colors can be added (in addition to red and green) to represent the “heat” degree (“temperature”) of components. One example is the use of yellow in FIG. 9 to indicate the mediocre performance between red and green.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for determining temperature of one or more business components, the temperature of one or more business components being a degree to which said one or more components are associated with one or more business strategies and/or pain points, comprising:
determining temperatures for metrics associated with a business component using benchmark data;
aggregating the temperatures for metrics using a selected algorithm to determine a representative temperature for the business component;
providing a spectrum of colors to represent the range of temperatures; and
presenting the representative temperature as a color from the spectrum of colors.

2. The method of claim 1, wherein the step of providing a spectrum of colors include using different colors to represent a range of temperatures.

3. The method of claim 2, wherein the step of determining, aggregating and presenting are performed for a plurality of business components.

4. The method of claim 3, wherein the representative temperature for each of the plurality of business components are presented as a color on a component business model representation.

5. The method of claim 1, wherein the selected algorithm includes an “at least one” algorithm, in which a business component is identified as being hot if at least one of associated metrics has as-is value worse than a benchmark value.

6. The method of claim 1, wherein the selected algorithm includes an “all” algorithm, in which a business component is identified as being hot if all of associated metrics have as-is value worse than a benchmark value.

7. The method of claim 1, wherein the selected algorithm includes “majority without weights” algorithm, in which a business component is identified as being hot if more than half of associated metrics have as-is value worse than a benchmark value.

8. The method of claim 1, wherein the selected algorithm includes “majority with weights” algorithm, in which a weight value is assigned to each associated metric.

9. A program storage device readable by a machine, tangibly embodying a program of instructions executable by the machine to perform a method of determining temperature of one or more business components, the temperature of one or more business components being a degree to which said one or more components are associated with one or more business strategies and/or pain points, comprising:
determining temperatures for metrics associated with a business component using benchmark data;
aggregating the temperatures for metrics using a selected algorithm to determine a representative temperature for the business component;
providing a spectrum of colors to represent the range of temperatures; and
presenting the representative temperature as a color from the spectrum of colors.

10. The program storage device of claim 9, wherein the step of providing a spectrum of colors include using different colors to represent a range of temperatures.

11. The program storage device of claim 10, wherein the step of determining, aggregating and presenting are performed for a plurality of business components.

12. The program storage device of claim 11, wherein the representative temperature for each of the plurality of business components are presented as a color on a component business model representation.

13. The program storage device of claim 9, wherein the selected algorithm includes an “at least one” algorithm, in which a business component is identified as being hot if at least one of associated metrics has as-is value worse than a benchmark value.

14. The program storage device of claim 9, wherein the selected algorithm includes an “all” algorithm, in which a business component is identified as being hot if all of associated metrics have as-is value worse than a benchmark value.

15. The program storage device of claim 9, wherein the selected algorithm includes “majority without weights” algorithm, in which a business component is identified as being hot if more than half of associated metrics have as-is value worse than a benchmark value.

16. The program storage device of claim 9, wherein the selected algorithm includes “majority with weights” algorithm, in which a weight value is assigned to each associated metric.

17. A system for determining temperature of one or more business components, the temperature of one or more business components being a degree to which said one or more components are associated with one or more business strategies and/or pain points, comprising:
means for determining temperatures for metrics associated with a business component using benchmark data;
means for aggregating the temperatures for metrics using a selected algorithm to determine a representative temperature for the business component;
means for providing a spectrum of colors to represent the range of temperatures; and
means for presenting the representative temperature as a color from the spectrum of colors.

18. The system of claim 17, wherein the means for providing a spectrum of colors uses different colors to represent a range of temperatures.

19. The system of claim 18, wherein the determining, aggregating and presenting are performed for a plurality of business components.

20. The system of claim 19, wherein the representative temperature for each of the plurality of business components are presented as a color on a component business model representation.

21. The system of claim 17, wherein the selected algorithm includes an “at least one” algorithm, in which a business component is identified as being hot if at least one of associated metrics has as-is value worse than a benchmark value.

22. The system of claim 17, wherein the selected algorithm includes an “all” algorithm, in which a business component is identified as being hot if all of associated metrics have as-is value worse than a benchmark value.

23. The system of claim 17, wherein the selected algorithm includes “majority without weights” algorithm, in which a business component is identified as being hot if more than half of associated metrics have as-is value worse than a benchmark value.

24. The system of claim 17, wherein the selected algorithm includes “majority with weights” algorithm, in which a weight value is assigned to each associated metric.

25. A system for determining temperature of one or more business components, the temperature of one or more business components being a degree to which said one or more components are associated with one or more business strategies and/or pain points, comprising:
a computer-implemented module operable to determine temperatures for metrics associated with a business component using benchmark data, the temperature being a degree to which a metric is associated with one or more business strategies and/or pain points;
a computer-implemented module operable to aggregate the temperatures for metrics using a selected algorithm to determine a representative temperature for the business component;
a computer-implemented module operable to provide a spectrum of colors to represent the range of temperatures; and
a computer-implemented user interface module operable to present the representative temperature as a color from the spectrum of colors.

26. The system of claim 25, the computer-implemented module operable to provide a spectrum of colors uses different colors to represent a range of temperatures.

27. The system of claim 25, wherein the computer-implemented module operable to determine temperatures for metrics determines said temperatures for metrics based on as-is value, benchmark value and median value associated with said metrics.
